(19) United States
(12) Patent Application Publication
(10) Pub. No.: US 2013/0013252 A1
(43) Pub. Date: Jan. 10, 2013

(54) LIGHT-EMITTING DEVICE, DISPLAY APPARATUS, AND METHOD FOR DESIGNING REFLECTIVE MEMBER

(76) Inventors: Yasuhiro Ono, Osaka (JP); Makoto Masuda, Osaka (JP); Kenzo Ohkubo, Osaka (JP); Nobuhiro Shirai, Osaka (JP); Takasumi Wada, Osaka (JP)

(21) Appl. No.: 13/533,369

(22) Filed: Jun. 26, 2012

(30) Foreign Application Priority Data
Jul. 6, 2011 (JP) JP2011-150475

(51) Int. Cl. F21V 13/04; G01B 11/24; G06F 15/00; G09F 13/14

(52) U.S. Cl. 702/167; 362/308; 362/97.1

(57) ABSTRACT

A backlight unit has a printed circuit board, a plurality of light-emitting portions each including a base, an LED chip, and a lens, and a reflective member surrounding the light-emitting portion. An area δ of a figure defining the contour of the reflective member as planarly viewed in an optical-axis direction parallel to an optical axis of the LED chip is determined on the basis of γ×β/α in which a quantity of light which exits through the transmitting region of the lens is represented by α, a quantity of light which exits through the entire surface of the lens is represented by β, and an area of the lens as planarly viewed in the optical-axis direction is represented by γ.

### CROSS-REFERENCE TO RELATED APPLICATION

This application claims priority to Japanese Patent Application No. 2011-150475, which was filed on Jul. 6, 2011, the contents of which are incorporated herein by reference in its entirety.

### BACKGROUND OF THE TECHNOLOGY

1. Field of the Technology

The present technology relates to a light-emitting device, a display apparatus, and a method for designing a reflective member.

2. Description of the Related Art

A display apparatus has a display panel. The display panel has a constitution that liquid crystal is sealed between two transparent substrates. Upon application of voltage, the orientation of liquid crystal molecules is varied with a consequent change in light transmittance, so that a predetermined image or the like is displayed in an optical manner. Liquid crystal does not emit light by itself as a light emitter. Therefore, in the display apparatus, for example, at the back of a transmissive display panel is disposed a backlight unit which is an illuminating device for applying light to the display panel through a cold cathode fluorescent tube (CCFL), a light emitting diode (LED), or the like serving as a light source.

Backlight units are broadly classified as a so-called direct-lighting type in which CCFL, LED, or the like serving as light sources are arranged on the bottom surface of a display panel for light emission, and a so-called edge-lighting type in which CCFL, LED, or the like serving as light sources are arranged at the edge portion of a transparent plate called a light guide plate, and light is illuminated on the front surface of the panel through the edge of the light guide plate with printed dots or patterns formed at the back.

Although LED has excellent characteristics, for example, it consumes much less power, has a longer operable life, and lessens environmental burden without the use of mercury, its use as a light source for a backlight unit has fallen behind because of its expensiveness and high directivity, and the fact that there had been no white-color LED prior to the invention of a blue-color LED. However, in recent years, as white-color LED which is higher in color rendition and in brightness has come into widespread use for illumination application purposes, LED is becoming less expensive. In keeping with this trend, as a light source for a backlight unit, the shift from CCFL to LED has picked up momentum.

Considering that LED has high directivity, a backlight unit of the edge-lighting type has the advantage over a backlight unit of the direct-lighting type from the standpoint of effecting light emission in such a way that a display panel exhibits uniform surface brightness in a planar direction thereof, or planar direction. However, the edge-lighting type backlight unit poses the problems that localized arrangement of light sources at the edge portion of the light guide plate results in concentration of heat emanating from the light sources, and the size of the bezel portion of the display panel is inevitably increased. Furthermore, the edge-lighting type backlight unit is subjected to severe restrictions in terms of local dimming control which attracts attention as a control technique capable of display of high-quality images and energy saving, and is therefore incapable of split-region control that allows production of high-quality displayed images and low power consumption.

In view of the foregoing, studies are going on to come up with a method by which, even if highly-directional LED is used as a light source in a direct-lighting type backlight unit having an advantage in its suitability for local dimming control, light can be applied to a display panel in such a way that the display panel exhibits uniform surface brightness in the planar direction. For example, in Japanese Unexamined Patent Publication JP-A 2010-238420, there is described an illuminating apparatus intended for uniformity in brightness, which is composed of a box-shaped frame member which defines a single region to be illuminated in a body to be illuminated, a printed circuit board disposed on the bottom surface of the frame member, and a light-emitting device surrounded by the frame member. The light-emitting device includes a light-emitting element disposed on the printed circuit board; a lens wherein one part of light emitted from the light-emitting device exits therefrom through the upper surface thereof and another part of the light exits therefrom through the side surface thereof; and a diffusively-reflecting sheet disposed in a location on the frame member other than the location where the printed circuit board is mounted.

In the illuminating apparatus described in JP-A 2010-238420, on the back surface of the to-be-illuminated body, namely a display panel, is defined a single to-be-illuminated region by the frame member. The to-be-illuminated region includes a region to be illuminated with direct light, to which light from the light-emitting device that has passed through the upper surface of the lens is directly applied, and a region to be illuminated with diffused light, to which light from the light-emitting device that has passed through the side surface of the lens and then diffused by diffusively-reflecting sheet is applied. That is, in the illuminating apparatus described in JP-A 2010-238420, not only it is possible to apply light emitted from the light-emitting device directly to the display panel, but it is also possible to diffuse light emitted from the light-emitting device on the surface of the diffusively-reflecting sheet by the lens, so that the resultant diffused light is applied to the display panel. This makes it possible to render the brightness of the display panel uniform in the planar direction.

However, in the light-emitting device provided in the illuminating apparatus described in JP-A 2010-238420, neither the quantity of light from the light-emitting device that is directly applied to the display panel nor the quantity of light from the light-emitting device that is diffused by the diffusively-reflecting sheet and then applied to the display panel is adjusted properly. This could cause a large difference between the light quantity per unit area in the region to be illuminated with direct light and the light quantity per unit area in the region to be illuminated with diffused light, wherefore uniformity in illumination light is not always achieved successfully.

### SUMMARY OF THE TECHNOLOGY

The technology has been devised to solve the problem as mentioned above, and accordingly an object of the technology is to provide a light-emitting device capable of applying light to a to-be-illuminated body in such a way that the to-be-illuminated body exhibits uniform brightness in the planar direction, a display apparatus, and a method for designing a reflective member.

The technology provides a light-emitting device for applying light to a body to be illuminated, comprising:

a light-emitting element that emits light;

a lens disposed face-to-face with the light-emitting element while covering the light-emitting element, the lens including a transmitting region for light transmission and a reflecting region for light reflection which surrounds the transmitting region; and

a reflective member that reflects light, the reflective member being disposed around the lens,

an area δ [cm²] of a figure defining a contour of the reflective member as planarly viewed in an optical-axis direction parallel to an optical axis of the light-emitting element, being determined on a basis of γ×β/α, in which a quantity of light which exits from the lens through the transmitting region is represented by α [lm·s], a quantity of light which exits from the lens through an entire surface of the lens is represented by β [lm·s], and an area of the lens as planarly viewed in the optical-axis direction is represented by γ [cm²].

It is preferable that the area δ [cm²] fulfills the following formula (1):

γ×β/α×90%≦δ≦γ×β/α×100% (1).

Moreover, it is preferable that the transmitting region has a diffusing part for light diffusion therein.

Moreover, it is preferable that the lens has a second transmitting region surrounding the reflecting region, for transmitting light in such a way that the light travels in a direction farther away from the optical axis than the light which passes through the transmitting region.

The technology provides a display apparatus comprising:

a display panel; and

an illuminating apparatus equipped with the light-emitting device mentioned above, the illuminating apparatus applying light so that the display panel can be illuminated with light at its back. The technology provides a method for designing a reflective member of a light-emitting device comprising a light-emitting element that emits light, a lens disposed face-to-face with the light-emitting element while covering the light-emitting element, the lens including a transmitting region for light transmission and a reflecting region for light reflection which surrounds the transmitting region, and the reflective member that reflects light, the reflective member being disposed around the lens, the method comprising:

a step of measuring α [lm·s] representing a quantity of light which exits from the lens through the transmitting region;

a step of measuring β [lm·s] representing a quantity of light which exits from the lens through an entire surface of the lens;

a step of measuring γ [cm²] representing an area of the lens as planarly viewed in an optical-axis direction parallel to an optical axis of the light-emitting element; and

a step of determining an area δ [cm²] of a figure defining a contour of the reflective member as planarly viewed in the optical-axis direction within a range from a lower limit represented as γ×β/α×90% to an upper limit represented as γ×β/α×100%, and then designing the reflective member so as to fulfill a thusly determined value.

The area δ is determined on the basis of γ×β/α, and more specifically the area δ is equal to 90 to 100% of γ×β/α. That is, the quantity of light per unit area in an entire to-be-illuminated region which is illuminated with light by the light-emitting element is substantially the same as the quantity of light per unit area in that part of the to-be-illuminated region which faces the lens. This makes it possible to avoid that the quantity of light applied to that part of the to-be-illuminated region which faces the lens becomes considerably large as compared with the quantity of light applied to different regions. Thus, light can be applied to a to-be-illuminated body in such a way that the brightness is uniform throughout the to-be-illuminated body in the planar direction thereof.

By virtue of the diffusing part formed in the transmitting region, the light which has passed through the transmitting region can be applied to the to-be-illuminated body while being diffused over a wide range. In consequence, light can be applied to the to-be-illuminated body with a higher degree of uniformity in the brightness of the to-be-illuminated body in the planar direction.

The second transmitting region of the lens makes it possible to apply transmitted light to that region of the to-be-illuminated body which is located far away from the lens. In consequence, light can be applied the to-be-illuminated body with a higher degree of uniformity in the brightness of the to-be-illuminated body in the planar direction.

The display panel can be illuminated with uniform light by the illuminating apparatus equipped with the light-emitting device. This allows display of high-quality images.

It is possible to design efficiently the light-emitting device capable of applying light to a to-be-illuminated body in such a way that the to-be-illuminated body exhibits uniform brightness in the planar direction.

### BRIEF DESCRIPTION OF THE DRAWINGS

Other and further objects, features, and advantages of the technology will be more explicit from the following detailed description taken with reference to the drawings wherein:

FIG. 1 is an exploded perspective view showing the structure of a liquid-crystal display apparatus;

FIG. 2 is a view schematically showing part of the section of the liquid-crystal display apparatus taken along the line A-A of FIG. 1;

FIG. 3A is a view showing the positional relationship between an LED chip supported by a base and a lens;

FIGS. 3B to 3D are views illustrating the base and the LED chip;

FIG. 3E is a view showing the LED chip and the base mounted on a printed circuit board;

FIG. 4 is a view for explaining an optical path of light emitted from the LED chip;

FIG. 5 is a perspective view of a reflective member and the lens;

FIG. 6 is a view showing emission intensity of light emitted from the LED chip; and

FIG. 7 is a view for explaining advantageous effects.

### DETAILED DESCRIPTION

Now referring to the drawings, preferred embodiments are described below.

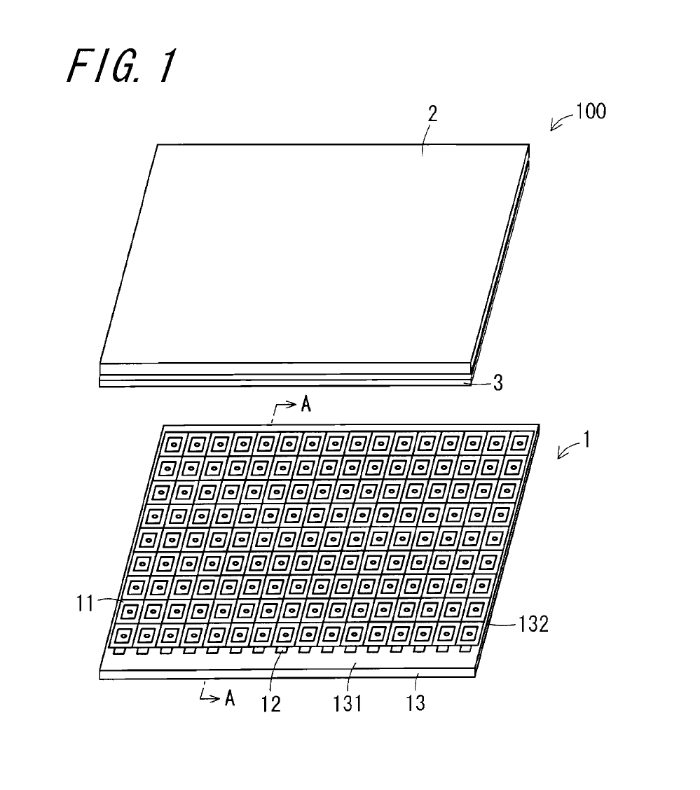

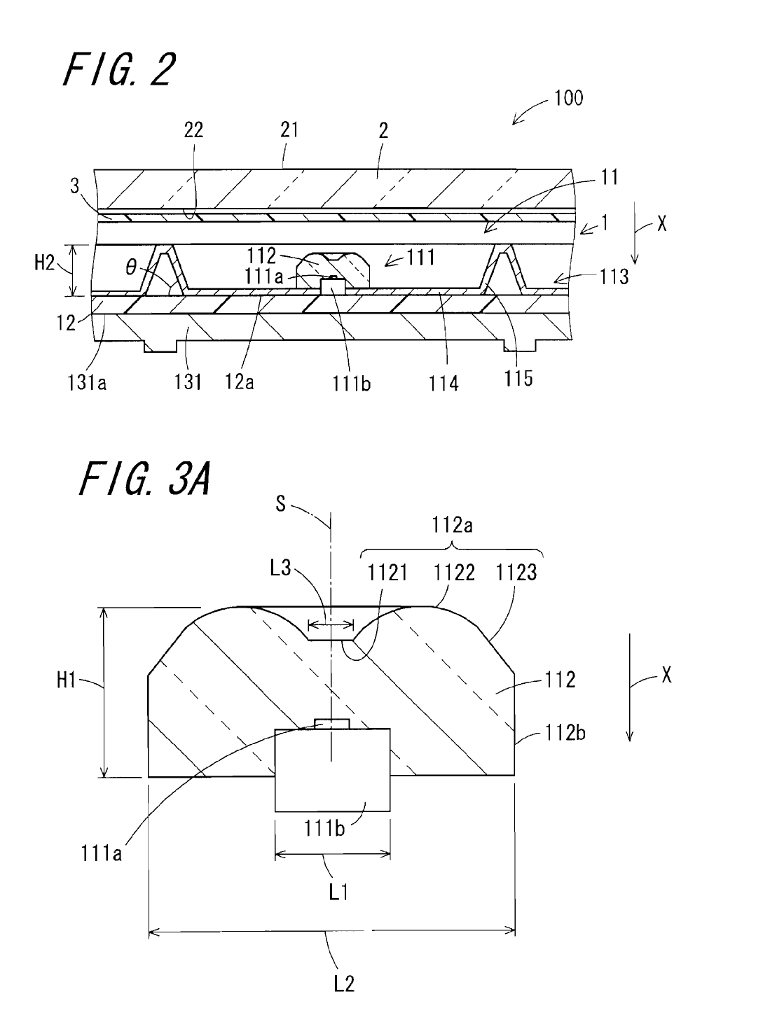

FIG. 1 is an exploded perspective view showing the structure of a liquid-crystal display apparatus 100 in accordance with an embodiment. FIG. 2 is a view schematically showing part of the section of the liquid-crystal display apparatus 100 taken along the line A-A of FIG. 1. The liquid-crystal display apparatus 100 implemented as a display apparatus according to the embodiment is designed for use in television sets, personal computers, and so forth, for showing an image on a display screen in response to output of image information. The display screen is constructed of a liquid-crystal panel 2 which is a transmissive display panel having liquid-crystal elements. The liquid-crystal panel 2 has the form of a rectangular flat plate. Two surfaces of the liquid-crystal panel 2 in a thickness direction thereof will be referred to as a front surface 21 and a rear surface 22, respectively. The liquid-crystal display apparatus 100 shows an image in such a way that the image is viewable in a direction from the front surface 21 toward the rear surface 22.

The liquid-crystal display apparatus 100 includes the liquid-crystal panel 2 and a backlight unit 1. The liquid-crystal panel 2 is supported on a sidewall portion 132 in parallel to a bottom surface 131a of a bottom portion 131 of a frame member 13 included in the backlight unit 1. The liquid-crystal panel 2 includes two substrates, and is shaped like a rectangular plate when viewed in the thickness direction thereof. The liquid-crystal panel 2 includes a switching element such as TFT (thin film transistor), and liquid crystal is filled in a gap between the two substrates. The liquid-crystal panel 2 performs display function through back-lighting from the backlight unit 1 disposed at the side of the rear surface 22 thereof. The two substrates are provided with a driver (source driver) used for pixel driving control in the liquid-crystal panel 2, and various elements and wiring lines.

Moreover, in the liquid-crystal display apparatus 100, a diffusion plate 3 is disposed between the liquid-crystal panel 2 and the backlight unit 1 in parallel to the liquid-crystal panel 2. A prism sheet may be interposed between the liquid-crystal panel 2 and the diffusion plate 3.

The diffusion plate 3 diffuses light emitted from the backlight unit 1 in the planar direction thereof to prevent localized brightness variations. The prism sheet controls the traveling direction of light that has reached the rear-surface 22 side through the diffusion plate 3 in such a way that the light travels toward the front surface 21. In the diffusion plate 3, in the interest of prevention of unevenness in brightness in the planar direction, the traveling direction of light involves, as vector components, many planar direction-wise components. On the other hand, in the prism sheet, the traveling direction of light involving many planar direction-wise vector components is converted into the traveling direction of light involving many thickness direction-wise components. More specifically, the prism sheet is formed with a number of lenses or prismatic portions arranged in the planar direction for reduction in the degree of diffusion of light traveling in the thickness direction. This helps increase the brightness of the display in the liquid-crystal display apparatus 100.

The backlight unit 1 is a so-called direct-lighting type backlight device for applying light to the liquid-crystal panel 2 from the rear-surface 22 side. The backlight unit 1 includes a plurality of light-emitting devices 11 for applying light to the liquid-crystal panel 2, a plurality of printed circuit boards 12, and the frame member 13.

The frame member 13 serves as a basic structure of the backlight unit 1, and is composed of the flat plate-shaped bottom portion 131 placed face-to-face with the liquid-crystal panel 2, with a predetermined spacing secured between them, and the sidewall portion 132 which is continuous with the bottom portion 131 so as to extend upright therefrom. The bottom portion 131 is rectangular-shaped when viewed in the thickness direction thereof, and its size is slightly larger than the size of the liquid-crystal panel 2. The sidewall portion 132 is so formed as to extend upright toward the front surface 21 of the liquid-crystal panel 2 from each of two edges of the bottom portion 131 defining the short sides of the rectangular shape and the other two edges of the bottom portion defining the long sides thereof. That is, four flat plate-shaped sidewall portions 132 are formed along the periphery of the bottom portion 131.

The printed circuit board 12 is fixed to the bottom surface 131a of the bottom portion 131 of the frame member 13. On a mounting surface 12a of the printed circuit board 12 are arranged a plurality of light-emitting portions 111 which will hereafter be described. The printed circuit board 12 is a longitudinally-elongated member, and its length in the direction of width thereof perpendicular to the longitudinal direction is set for example at 10 mm, and its length in the thickness direction thereof perpendicular to the longitudinal direction is set for example at 0.8 mm. The two or more printed circuit boards 12 are juxtaposed in the width direction so as to be spaced 30 mm apart, for example. For example, the printed circuit board 12 is made of a glass epoxy substrate having an electrically conductive layer formed on both sides.

The printed circuit board 12 is so formed as to extend to the sidewall portion 132 of the frame member 13 in the longitudinal direction. The sidewall portion 132 is provided with a connector for feeding electric power to the printed circuit board 12. The printed circuit board 12 is connected to the connector, so that electric power can be fed to each of the light-emitting devices 11 through the electrically conductive layers formed on the printed circuit board 12.

The plurality of light-emitting devices 11 serve to apply light to the liquid-crystal panel 2. In this embodiment, two or more light-emitting devices 11 are arranged in a group, and the plurality of printed circuit boards 12 each having the two or more light-emitting devices 11 are juxtaposed face-to-face with the entire region of the rear surface 22 of the liquid-crystal panel 2, with the diffusion plate 3 lying between them, thereby providing matrix arrangement of the light-emitting devices 11. Each of the light-emitting devices 11 is square-shaped when planarly viewed in an X direction perpendicular to the bottom portion 131 of the frame member 13. The light-emitting devices 11 are so disposed that the liquid-crystal panel 2-sided surface of the diffusion plate 3 exhibits a brightness of 6000 cd/m². For example, the length of a side of the square shape is set at 40 mm.

Each of the two or more light-emitting devices 11 has the light-emitting portion 111 and a reflective member 113 placed around the light-emitting portion 111. The light-emitting portion 111 includes a light-emitting diode (LED) chip 111a which is a light-emitting element, a base 111b for supporting the LED chip 111a, and a lens 112 which is an optical member.

The reflective member 113 includes a base portion 114 disposed on the bottom surface 131a of the bottom portion 131 of the frame member 13 in parallel to the bottom surface 131a, and an inclined portion 115 surrounding the base portion 114, the inclination of which is adjusted so that the distance to the light-emitting portion 111 increases with decreasing proximity to the printed circuit board 12. The reflective member 113 of each light-emitting device 11 defines, on a target body to be illuminated, a region to be illuminated corresponding to the light-emitting device 11. For the sake of local dimming control, the backlight unit 1 is so disposed that the area of each to-be-illuminated region on the to-be-illuminated body is substantially equal to the area of a figure defined by the contour of the reflective member 113 as planarly viewed in the X direction. In this embodiment, the to-be-illuminated body refers to the diffusion plate 3. As the result of application of light to the diffusion plate 3, the liquid-crystal panel 2 is illuminated with light, thereby effecting the display of an image.

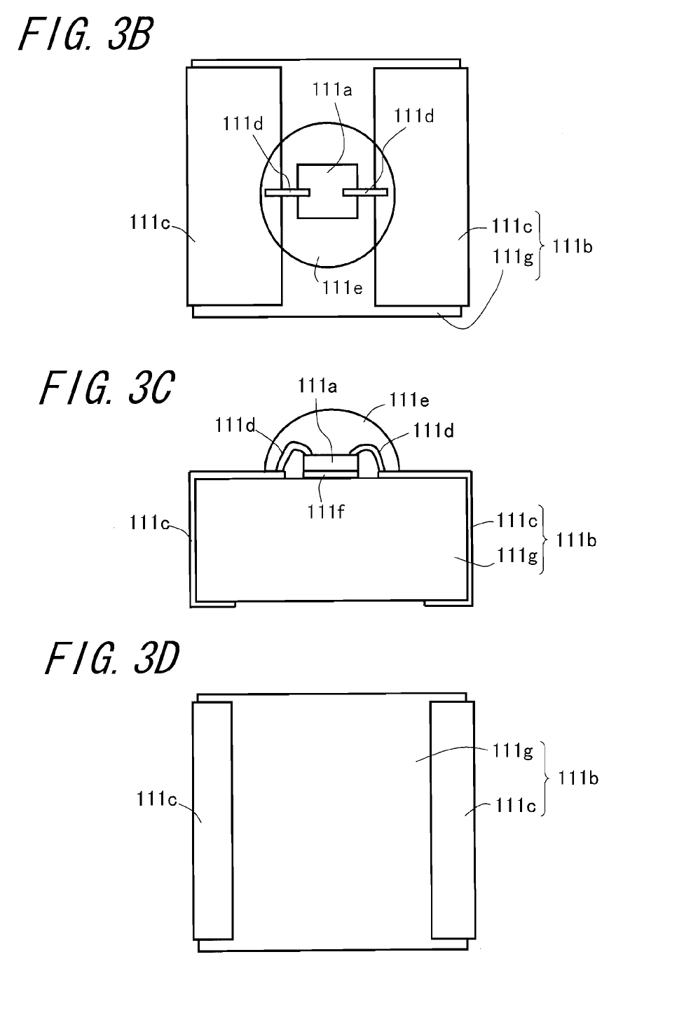

FIG. 3A is a view showing the positional relationship between the LED chip 111a supported by the base 111b and the lens 112.

The base 111b is a member for supporting the LED chip 111a. In the base 111b, its support surface for supporting the LED chip 111a is square-shaped when planarly viewed in the X direction. For example, a length L1 of a side of the square shape is set at 3 mm, and the height of the base 111b is set at 1 mm.

FIGS. 3B to 3D are views illustrating the base 111b and the LED chip 111a, with FIG. 3B showing a plan view thereof, FIG. 3C showing a front view thereof, and FIG. 3D showing a bottom view thereof. As shown in FIGS. 3B to 3D, the base 111b includes a base main body 111g made of ceramics and two electrodes 111c disposed on the base main body 111g. The LED chip 111a is fixedly attached to a midportion of the top surface of the base main body 111g serving as the support surface of the base 111b by a bonding member 111f. The two electrodes 111c, which are spaced apart, are each extend over the top surface, side surface, and bottom surface of the base main body 111g.

The LED chip 111a has two terminals (not shown) connected to the two electrodes 111c, respectively, via two bonding wires 111d, respectively. The LED chip 111a and the bonding wires 111d are sealed with transparent resin 111e such as silicone resin.

In FIG. 3E, there are shown the LED chip 111a and the base 111b mounted on the printed circuit board 12. The LED chip 111a is mounted on the printed circuit board 12, with the base 111b lying between them, for emitting light in a direction away from the printed circuit board 12. The direction of an optical axis S of the LED chip 111a is parallel to the X direction. When the light-emitting device 11 is planarly viewed in the X direction, the LED chip 111a is located centrally of the base 111b. In the plurality of light-emitting devices 11, the separate LED chips 111a thereof can be controlled on an individual basis in respect of light emission. This allows the backlight unit 1 to perform local dimming control.

In order to mount the LED chip 111a and the base 111b on the printed circuit board 12, to begin with, solder is put on each of two connection terminal portions 121 formed in a conductor-layer pattern on the printed circuit board 12. Then, the base 111b and the LED chip 111a fixed to the base 111b are placed on the printed circuit board 12 by, for example, an automated machine (not shown), in such a way that the two electrodes 111c situated on the bottom surface of the base main body 111g are brought into registry with their respective solder. The printed circuit board 12 carrying the base 111b and the LED chip 111a fixed to the base 111b is delivered to a reflow bath capable of infrared radiation. With the solder heated to a temperature of about 260° C., the base 111b is soldered to the printed circuit board 12.

The lens 112, which is formed in contact with the LED chip 111a by the insert molding technique so as to cover the LED chip 111a and the base 111b supporting the LED chip 111a, effects reflection or refraction of light emitted from the LED chip 111a in a plurality of directions. The lens 112 is a transparent lens made for example of silicone resin or acrylic resin.

In the lens 112, its top surface 112a facing the liquid-crystal panel 2 is curved, with a recess formed centrally thereof. Moreover, its side surface 112b is shaped like the periphery of a cylindrical column whose axis coincides with the optical axis S of the LED chip 111a. For example, a diameter L2 of the section of the lens 112 perpendicular to the optical axis S is set at 10 mm. The lens 112 is so formed as to extend outward relative to the base 111b. That is, the lens 112 is larger than the base 111b with respect to a direction perpendicular to the optical axis S of the LED chip 111a (the diameter L2 of the lens 112 is greater than the length L1 of a side of the square defining the shape of the support surface of the base 111b). In this way, by forming the lens 112 so as to extend outward relative to the base 111b, it is possible to diffuse the light emitted from the LED chip 111a over a wide range by the lens 112.

Moreover, a height H1 of the lens 112 is set at 4.5 mm, for example. The height H1 is smaller than the diameter L2. In other words, the lens 112 is so configured that the length in a direction perpendicular to the optical axis S of the LED chip 111a (the diameter L2) is greater than the height H1. Light entering the lens 112 is diffused in a direction intersected by the optical axis S within the lens 112.

The reason for adjusting the diameter L2 to be greater than the height Hi as described above is to slim the backlight unit 1 down, as well as to ensure uniformity in light application to the liquid-crystal panel 2. In order to make the backlight unit 1 lower in profile, the height H1 of the lens 112 needs to be minimized; that is, the lens 112 needs to be thinned as much as possible. However, the reduction in thickness of the lens 112 is likely to cause illuminance variations at the rear surface 22 of the liquid-crystal panel 2, which may result in lack of uniformity in brightness at the front surface 21 of the liquid-crystal panel 2. Especially in a case where a somewhat longer distance is secured between the adjacent LED chips 111a, a region between the adjacent LED chips 111a is located far away from the LED chip 111a and therefore becomes lower in light-quantity level, in consequence whereof there results illuminance (brightness) variations between that region and a region close to the LED chip 111a at the rear surface 22 of the liquid-crystal panel 2. In order to apply the light emitted from the LED chip 111a to the region located far away from the LED chip 111a through the lens 112, the lens 112 needs to have a reasonably large diameter L2. Thus, in this embodiment, the slimming-down of the backlight unit 1 and uniform application of light to the liquid-crystal panel 2 can be achieved by setting the diameter L2 to be greater than the height H1 in the lens 112.

If the diameter L2 of the lens 112 is set to be smaller than the height H1 of the lens 112, it will be difficult to achieve the above-described slimming-down and uniform light application, and in addition, in the insert-molding process for forming the lens 112 in alignment with the LED chip 111a, there arises the likelihood of poor balance between them. Furthermore, the light-emitting portion 111 composed of the LED chip 111a, the base 111b, and the lens 112 formed by means of insert molding could be soldered to the printed circuit board 12 in an unbalanced state, which results in assembly problems.

The top surface 112a of the lens 112, which is opposed to the LED chip 111a, includes a central portion 1121 parallel to the diffusion plate 3, a first curved portion 1122 surrounding the central portion 1121, and a second curved portion 1123 surrounding the first curved portion 1122. On the surface of the lens 112, the central portion 1121 and the second curved portion 1123 of the top surface 112a, as well as the side surface 112b, serve as transmitting regions for effecting transmission of light which has been emitted from the LED chip 111a and then reached the lens 112 through its interior. On the other hand, the first curved portion 1122 of the top surface 112a serves as a reflecting region for reflecting the light which has been emitted from the LED chip 111a and then reached the lens 112 through its interior toward the side surface 112b. In this embodiment, the lens 112 is contacted on its bottom surface by the base portion 114 of the reflective member 113, thereby preventing the exit of light from the bottom surface.

The central portion 1121 is formed centrally of the top surface 112a facing the liquid-crystal panel 2. The center of the central portion 1121 (viz., the optical axis of the lens 112) is located on the optical axis S of the LED chip 111a. The central portion 1121 is circularly shaped in parallel with the light-emitting surface of the LED chip 111a, and its diameter L3 is set at 1 mm, for example. It is preferable that the central portion 1121 has a diffusing part for light diffusion formed in a midportion thereof in the planar direction. The diffusing part can be formed by performing surface roughening treatment on the planar midportion of the central portion 1121, or can be formed by placing a disc-shaped member, which is obtained by dispersing, in transparent resin, beads of another transparent resin which differs in refractive index from that transparent resin, on the planar midportion of the central portion 1121. By way of another embodiment, instead of having the circular shape, the central portion 1121 may be defined by the periphery of a cone, the tip of which protrudes toward the LED chip 111a from an imaginary bottom surface coinciding with the circular shape.

The central portion 1121 is formed for the purpose of applying light to that region of the diffusion plate 3, viz., the to-be-illuminated body, which faces the central portion 1121. It is noted that, since the central portion 1121 is opposed to the LED chip 111a, when most of the light emitted from the LED chip 111a reaches the central portion 1121, and most part of the light passes directly through the central portion 1121, then the illuminance of the region facing the central portion 1121 is significantly increased. With this in view, in this embodiment, the diffusing part is provided for light-quantity adjustment. However, in the case where the central portion 1121 is defined by the periphery of the cone as described above, most of light is reflected from the central portion 1121, and thus the quantity of light which passes through the central portion 1121 is reduced. Therefore, it is not absolutely necessary to conduct light-quantity adjustment by the diffusing part.

The first curved portion 1122 is a circular curved surface which merges with the edge of the outer circumference of the central portion 1121, and extends gradually outwardly in one of the directions of the optical axis S of the LED chip 111a (the direction toward the liquid-crystal panel 2) while being curved in an inward direction as well as in the one optical-axis S direction in convex form. The first curved portion 1122, being used as the reflecting region, is designed to have a curve that allows total reflection of the light emitted from the LED chip 111a.

More specifically, of the light emitted from the LED chip 111a, a light portion which has reached the first curved portion 1122 is totally reflected from the first curved portion 1122, is then transmitted through the side surface 112b of the lens, and whereafter travels toward the reflective member 113. Upon reaching the reflective member 113, the light is diffused by the reflective member 113 so as to be applied to that region of the diffusion plate 3, viz., the to-be-illuminated body, which is not opposed to the LED chip 111a. In this way, the quantity of light applied to the region which is not confronted by the LED chip 111a can be increased.

In the interest of total reflection of the light emitted from the LED chip 111a, the first curved portion 1122 is so configured that the angle of incidence of the light emitted from the LED chip 111a is greater than or equal to a critical angle φ. For example, given that acrylic resin is used as the material for the lens 112, since the refractive index of the acrylic resin is 1.49, whereas the refractive index of air is 1, it follows that the relationship of sin φ=1/1.49 holds. A critical angle φ of 42.1° is derived from this relational expression, wherefore the first curved portion 1122 is so configured that the incident angle is greater than or equal to 42.1°.

The second curved portion 1123 is a circular curved surface which merges with the edge of the outer circumference of the first curved portion 1122, and extends gradually outwardly in the other of the directions of the optical axis S of the LED chip 111a (the direction away from the liquid-crystal panel 2) while being curved in an outward direction as well as in the one optical-axis S direction in convex form.

Of the light emitted from the LED chip 111a, a light portion which has reached the second curved portion 1123 is refracted in a direction toward the light-emitting portion 111 when passing through the second curved portion 1123 so as to travel toward the diffusion plate 3 and the reflective member 113. Upon reaching the reflective member 113, the light is diffused for travel toward the diffusion plate 3. The light thusly directed toward the diffusion plate 3 by the second curved portion 1123 is mainly applied to a region of the diffusion plate 3 that differs from the regions thereof illuminated with light directed by the central portion 1121 and the first curved portion 1122, respectively. This serves as a complement to the right quantity of light. Note that the second curved portion 1123 is required to allow transmission of light, and is therefore configured so that the incident angle is smaller than 42.1° to avoid total reflection of the light emitted from the LED chip 111a.

Thus, the lens 112 is configured to have the first curved portion 1122 for totally reflecting the light emitted from the LED chip 111a toward the side surface 112b of the lens 112, which is formed along the edge of the outer circumference of the central portion 1121, and the second curved portion 1123 for allowing refraction of the light emitted from the LED chip 111a, which is formed along the edge of the outer circumference of the first curved portion 1122. In general, the LED chip 111a has high directivity, and light quantity around the optical axis S is very large. The larger the exit angle of light with respect to the optical axis S becomes, the smaller light quantity becomes. Therefore, in order to increase the quantity of light illuminated on a region located relatively far away from the optical axis S of the LED chip 111a (viz., the optical axis of the lens 112), it is necessary to direct light having a smaller exit angle with respect to the optical axis S toward that region rather than light having a larger exit angle with respect to the optical axis S. In this embodiment, as has already been described, since the first curved portion 1122 capable of totally reflecting light toward that region is formed in contiguous relation around the central portion 1121 through which the optical axis S passes, it is possible to increase the quantity of light illuminated on that region. By contrast, if the second curved portion 1123 is formed in contiguous relation around the central portion 1121 and the first curved portion 1122 is formed in contiguous relation around the second curved portion 1123, light traveling toward the first curved portion 1122 will exhibit a large exit angle with respect to the optical axis S, in consequence whereof there results a decrease in the quantity of light totally reflected from the first curved portion 1122 to be illuminated on that region.

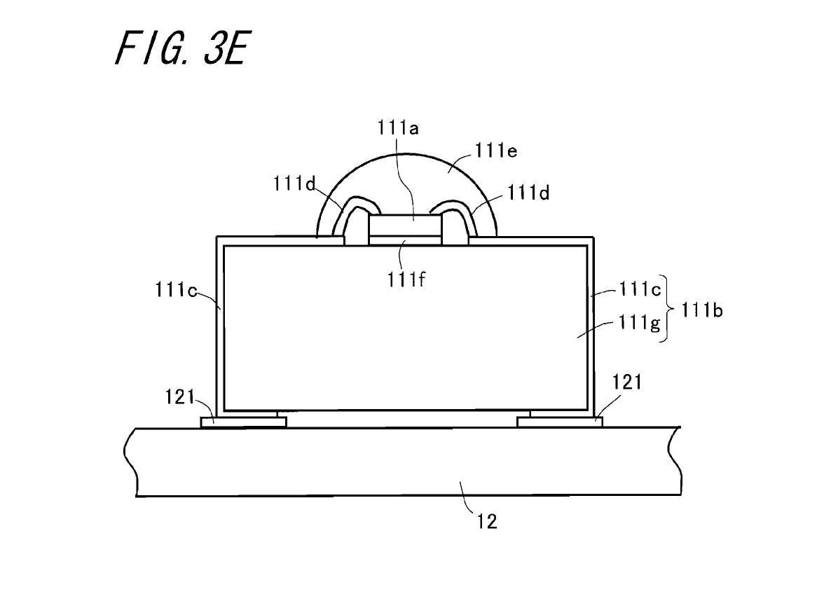

FIG. 4 is a view for explaining an optical path of light emitted from the LED chip 111a. The light emitted from the LED chip 111a enters the lens 112, and it is diffused by the lens 112. Specifically, of the light entering the lens 112, a light portion which has reached the central portion 1121 at the top surface 112a facing the diffusion plate 3, viz., the to-be-illuminated body, exits in a direction such as a direction indicated by arrow A1 for travel toward the diffusion plate 3. The light which has passed through the central portion 1121 is directly applied to the diffusion plate 3. In the range of the back surface of the diffusion plate 3 which is the to-be-illuminated body, a region which is illuminated with light by each light-emitting device 11 and has substantially the same dimension as that of the reflective member 113 will be referred to as a to-be-illuminated region. Moreover, a region to which is directly applied the light which has passed through the central portion 1121 will be referred to as a central part of the to-be-illuminated region, or central to-be-illuminated region, and a region other than the central to-be-illuminated region will be referred to as a peripheral part of the to-be-illuminated region, or a peripheral to-be-illuminated region. The distance between the light-emitting device 11 and the diffusion plate 3 which is the to-be-illuminated body is so determined that the area of the central to-be-illuminated region facing the lens 112 in the diffusion plate 3 is equal to the area of a figure defining the contour of the lens 112, namely the area of the circle having the diameter L2, when planarly viewed in the X direction.

Moreover, as shown in FIG. 4, light which has reached the first curved portion 1122 travels toward the side surface 112b after being totally reflected from the first curved portion 1122, and exits in a direction such as a direction indicated by arrow A2 from the side surface 112b. Upon exiting in a direction such as the arrow A2-indicated direction, the light reaches the reflective member 113 placed around the lens 112. After being reflected from the reflective member 113, the light is applied to the diffusion plate 3 which is the to-be-illuminated body. Light which has reached the second curved portion 1123 is refracted outwardly (in a direction away from the LED chip 111a) and exits in a direction such as a direction indicated by arrow A3 for travel toward the diffusion plate 3. Note that, in general, light emitted from LED exhibits high directionality, wherefore there is little light from LED chip 111a that travels directly toward the side surface 112b of the lens 112. Accordingly, of the light emitted from the LED chip 111a, most of light portions other than a light portion which passes through the central portion 1121 at the top surface 112a of the lens 112 are, as has already been described, either directed toward the reflective member 113 through the side surface 112b of the lens 112 and reflected from the reflective member 113 for travel toward the diffusion plate 3, or travels directly toward the diffusion plate 3 through the second curved portion 1123. In either case, the light is applied to the peripheral to-be-illuminated region in the diffusion plate 3.

In this embodiment, the LED chip 111a and the lens 112 are formed in accurate alignment with each other so that the lens 112 is placed in contact with the LED chip 111a, with its center (viz., the optical axis of the lens 112) located precisely on the optical axis S of the LED chip 111a. In order to form the LED chip 111a and the lens 112 in proper alignment, a few ways will be considered, i.e. adopting an insert-molding technique and fitting the LED chip 111a supported on the base 111b in the lens 112 molded in a predetermined shape. In this embodiment, the LED chip 111a and the lens 112 are formed in proper alignment by means of insert molding.

Molds used for the insert molding are broadly classified as an upper mold and a lower mold. A resin used as the raw material of the lens 112 is injected, through a resin injection port, into a space created by combining the upper mold and the lower mold, while holding the LED chip 111a in position. Alternatively, the insert molding may be effected by injecting a resin used as the raw material of the lens 112 into a space created by combining the upper mold and the lower mold through a resin injection port, while holding the LED chip 111a supported on the base 111b in position. By forming the LED chip 111a and the lens 112 by means of insert molding in that way, it is possible to ensure accurate alignment between the lens 112 and the LED chip 111a so that the lens 112 can be contacted by the LED chip 111a properly. Thus, the backlight unit 1 becomes capable of accurate reflection and refraction of light emitted from the LED chip 111a by the action of the lens 112 placed in contact with the LED chip 111a. Accordingly, even in the low-profile liquid-crystal display apparatus 100 in which the distance from the diffusion plate 3 to the printed circuit board 12 is short, light can be illuminated on the liquid-crystal panel 2 in such a way that the brightness is uniform throughout the panel in the planar direction.

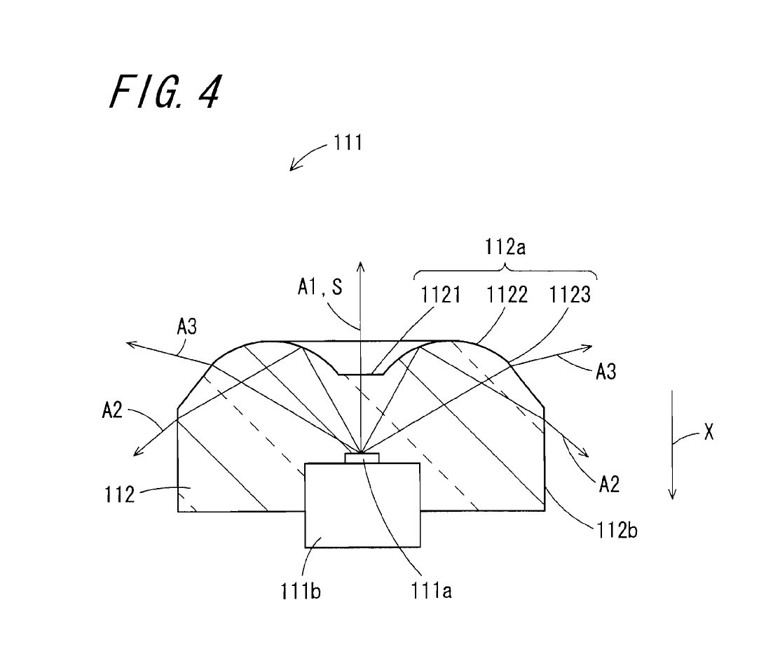

Next, the reflective member 113 will be explained with reference to FIGS. 2 and 5. FIG. 5 is a perspective view of the reflective member 113 and the lens 112, wherein the LED chip 111a and the base 111b which are covered with the lens 112 are omitted. The reflective member 113 has a polygonal-shaped contour, for example, square-shaped contour when planarly viewed in the X direction. The reflective member 113 includes the base portion 114 which has a centrally-located opening and is shaped as a square flat plate, the length of a side of which is 38.8 mm, and the inclined portion 115 surrounding the base portion 114, which is so inclined that the distance to the LED chip 111a increases with decreasing proximity to the printed circuit board 12. The reflective member 113 composed of the base portion 114 and the inclined portion 115 is disposed about the lens 112 in the form of an upside-down dome.

In this embodiment, the reflective member 113 has a square-shaped contour when planarly viewed in the X direction. The reflective member 113 is line-symmetrical about the diagonal line of the square. Further, the reflective member 113 is rotationally-symmetrical through 90° about the center point of the square.

The base portion 114 is so designed that each side of a square defining its shape as planarly viewed in the X direction is parallel to the direction of rows or columns of the matrix of a plurality of LED chips 111a. Moreover, the base portion 114 is formed along the printed circuit board 12, and has a square-shaped opening located centrally thereof when planarly viewed in the X direction. The length of a side of the square defining the shape of the opening is substantially equal to the length L1 of a side of the base 111b for supporting the LED chip 111a, so that the base 111b can be inserted into the opening.

The inclined portion 115 is a collective designation for four isosceles-trapezoidal flat plates 116 each having an isosceles-trapezoidal main surface. In each of the isosceles-trapezoidal flat plates 116, of its two opposite sides arranged in parallel to each other, the shorter one, namely a short side 116a merges with its respective side of the square-shaped base portion 114, and the longer one, namely a long side 116b is located farther away from the printed circuit board 12 than the base portion 114 in the X direction. The adjacent isosceles-trapezoidal flat plates 116 are continuous with each other at two non-parallel sides 116c opposed to each other, thereby defining a frame shape of the inclined portion 115.

An inclination angle θ between the inclined portion 115 and the printed circuit board 12 as shown in FIG. 2 is set at 80°, for example. Moreover, a height H2 of the inclined portion 115 in the X direction as shown in FIG. 2 is set at 5 mm, for example. By way of another embodiment, the inclination angle θ may be any one of angles falling within a range of 45° to 90°, and the reflective member 113 does not necessarily have to include the inclined portion 115.

The base portion 114 and the inclined portion 115 are each made of high-luminance PET (PolyEthylene Terephthalate), aluminum, or the like. The high-luminance PET is foamed PET containing a fluorescent agent. For example, E60V (product name) manufactured by TORAY Industries, Inc. can be used. The base portion 114 and the inclined portion 115 have a thickness in a range of 0.1 mm to 0.5 mm, for example.

In this embodiment, the surfaces of the base portion 114 and the inclined portion 115 which face the light-emitting portion 111 exhibit total reflectivity of 94%. The total reflectivity of the base portion 114 and the inclined portion 115 is greater than or equal to 90%, or preferably 100%. As specified in JIS H 0201:1998, total reflectivity refers to the sum of specular reflectivity and diffuse reflectivity, and its measurement can be conducted in conformity to JIS K 7375.

It is preferable that the base portion 114 and the inclined portion 115 which constitute the reflective member 113 are formed integrally with each other, and also the reflective members 113 provided in the plurality of light-emitting devices 11, respectively, are formed integrally with each other. As exemplary of methods for molding a plurality of reflective members 113 in one piece, in the case where the reflective member 113 is made of foamed PET, an extrusion molding technique may be adopted, and, in the case where the reflective member 113 is made of aluminum, a press working technique may be adopted. By molding the reflective members 113 respectively provided in the plurality of light-emitting devices 11 in one piece, it is possible to improve the accuracy of placement positions of the light-emitting devices 11 relative to the printed circuit board 12, as well as to reduce the number of process steps required for installation of the reflective members 113 during backlight-unit 1 assembly operation. Accordingly, the efficiency of assembly operation can be increased.

With respect to the reflective member 113 according to the embodiment, the area δ [cm²] of a figure defining the contour of the reflective member 113 as planarly viewed in the X direction fulfills the following formula (1):

γ×β/α×90%≦δ≦γ×β/α×100% (1).

In the formula, a [lm·s] represents the quantity of light which exits from the lens 112 through the central portion 1121 at the top surface 112a of the lens 112. β [lm·s] represents the quantity of light which exits from the lens 112 through the entire surface of the lens 112, namely the quantity of light which exits from the lens 112 through the top surface 112a and the side surface 112b of the lens 112. γ [cm²] represents the area of a figure defining the contour of the lens 112 as planarly viewed in the X direction.

In this embodiment, the figure defining the contour of the reflective member 113 including the base portion 114 and the inclined portion 115 as planarly viewed in the X direction is a square measuring 40 mm on each side, the area δ of which is 16 cm². By way of another embodiment, in the case where the inclined portion 115 is not provided, the area of a figure defining the contour of the base portion 114 as planarly viewed in the X direction corresponds to the area δ.

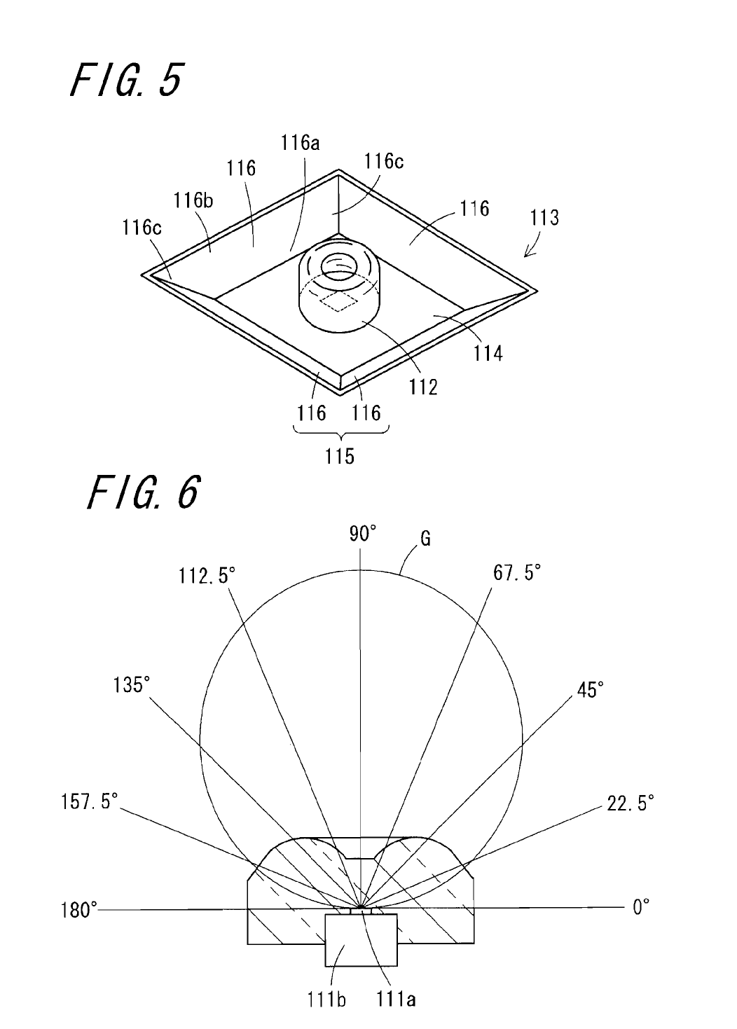

Moreover, in this embodiment, the figure defining the contour of the lens 112 as planarly viewed in the X direction is a circle having the diameter L2, the area γ of which is 1 cm². Therefore, on the basis of the above formula (1), the value of light quantity α/light quantity β falls within a range of 0.05625 to 0.0625. This means that the ratio of the quantity α of light which exits from the lens 112 through the central portion 1121 at the top surface 112a of the lens 112 to the quantity β of light which exits from the lens 112 through the top surface 112a and the side surface 112b of the lens 112 falls within a range of 5.625% to 6.25%. Correspondingly, the distribution of luminous intensity in the LED chip 111a can be represented by a graph G as shown in FIG. 6, for example. Note that the graph G indicates a luminous intensity distribution as observed in the absence of the lens 112.

As shown in FIG. 6, the lens 112 is designed in accordance with the intensity distribution of light emitted from the LED chip 111a so as to ensure that a sufficient quantity of light reaches each of the constituent portions 1121 to 1123 of the top surface 112a of the lens 112. Following the completion of design of the lens 112, the measurement of the area γ and the light quantity α, β can be effected. The light quantity α, β can be measured by a light-quantity measurement device using an integrating sphere. In order to measure the light quantity α, it is advisable to use a black-color member capable of light interception and absorption for covering the top surface 112a of the lens 112, excluding the central portion 1121. Following the completion of measurement of the area γ and the light quantity α, β, the area δ can be determined on the basis of the above formula (1). The reflective member 113 according to the embodiment can be designed in this way.

That is, in this embodiment, the lens 112 and the LED chip 111a are prepared first, and the light quantity α, β and the area γ are measured. After that, on the basis of the above formula (1), the upper limit and the lower limit of the area δ are calculated, and the value of the area δ is so determined as to fall within the prescribed range. The reflective member 113 is designed in this way. Note that, in so far as the formula (1) is fulfilled, the reflective member 113 does not necessarily have to be designed through the above-stated procedure. For example, the lens 112 can be designed after determination of the area δ of the reflective member 113. However, as has already been described, since the lens 112 needs to be designed in conformity with the characteristics of the LED chip 111a, by preparing the lens 112 first, it is possible to manufacture the light-emitting device 11 as a whole more efficiently.

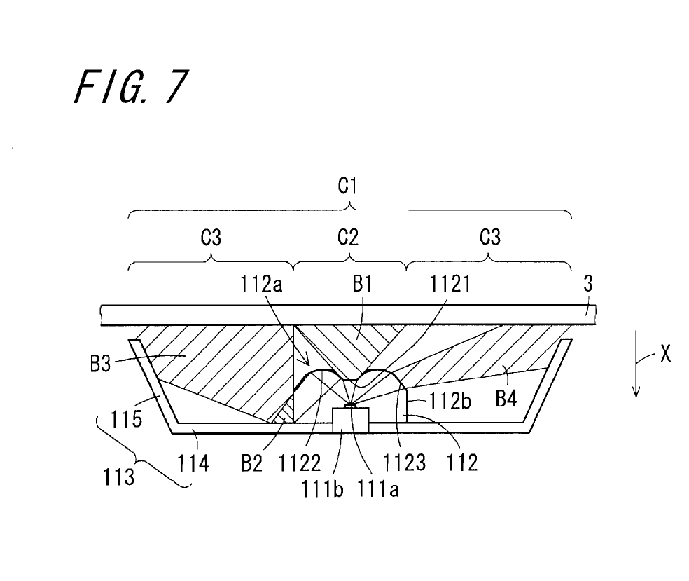

Advantageous effects of the thusly constructed backlight unit 1 will be explained with reference to FIG. 7. FIG. 7 corresponds to FIG. 2. As shown in FIG. 7, of the light which is emitted from the LED chip 111a and enters the lens 112, a light portion which has reached the central portion 1121 of the top surface 112a opposed to the diffusion plate 3, viz., the to-be-illuminated body, passes through the central portion 1121. The resultant transmitted light B1 is applied to a central to-be-illuminated region C2 facing the lens 112 in the to-be-illuminated region C1 of the diffusion plate 3. Moreover, of the light entering the lens 112, a light portion which has reached the first curved portion 1122 of the top surface 112a opposed to the diffusion plate 3 is totally reflected from the first curved portion 1122, is directed toward the side surface 112b while traveling through the interior of the lens 112, reaches the side surface 112b, and passes through the side surface 112b. The resultant transmitted light B2 reaches the base portion 114 of the reflective member 113, and is then diffused by the base portion 114. The resultant diffused light B3 is applied to a peripheral to-be-illuminated region C3 surrounding the central to-be-illuminated region C2 in the to-be-illuminated region C1 of the diffusion plate 3. Further, of the light entering the lens 112, a light portion which has reached the second curved portion 1123 of the top surface 112a opposed to the diffusion plate 3 passes through the second curved portion 1123. The resultant transmitted light B4 is applied to an outer-edge region C4 of the peripheral to-be-illuminated region C3 of the diffusion plate 3.

The light quantity of the transmitted light B1 corresponds to a of the formula (1), and the sum total of the light quantities of the transmitted light B1, the transmitted light B2, and the transmitted light B4 corresponds to β of the formula (1). Moreover, the sum total of the light quantities of the transmitted light B1, the transmitted light B4, and the diffused light B3 is represented by ε [lm·s]. Note that, as shown in FIG. 6, the light emitted from the LED chip 111a exhibits high directionality and thus travels mainly toward the diffusion plate 3. Therefore, the quantity of light from the LED chip 111a that directly reaches the side surface 112b of the lens 112 is very small.

The lens 112 is so designed that the area of the central to-be-illuminated region C2 of the diffusion plate 3 is equal to the area γ of the figure defining the contour of the lens 112 as planarly viewed in the X direction. Since the quantity of the transmitted light B1 applied to the central to-be-illuminated region C2 is given as α, it follows that the quantity of light per unit area in the central to-be-illuminated region C2 takes on the value of α/γ. On the other hand, the backlight unit 1 is so designed that the area of the to-be-illuminated region C1 of the diffusion plate 3 is equal to the area δ of the figure defining the contour of the reflective member 113 as planarly viewed in the X direction. Since the sum total of the light quantities of the transmitted light B1, the transmitted light B4, and the diffused light B3 applied to the to-be-illuminated region C1 is given as ε, it follows that the quantity of light per unit area in the to-be-illuminated region C1 takes on the value of ε/δ.

The reflective member 113 according to the embodiment is so configured that the area δ satisfies the formula (1). The formula (1) indicates that the area δ is substantially equal to γ×β/α, and more specifically the area δ is equal to 90% to 100% of γ×β/α. Moreover, since the diffused light B3 results from diffusion of the transmitted light B2 effected by the reflective member 113 having total reflectivity in a range of 90% to 100%, it follows that the light quantity ε is approximately equal to 90% to 100% of the light quantity β.

Accordingly, the quantity of light per unit area ε/δ in the to-be-illuminated region C1 becomes substantially the same as the quantity of light per unit area α/γ in the central to-be-illuminated region C2. That is, according to the light-emitting device 11, it is possible to suppress that the quantity of light applied to that region of the to-be-illuminated body which faces the lens 112 is considerably large as compared with the quantity of light applied to different regions. It will thus be seen that the light-emitting device 11 is capable of emitting light to a to-be-illuminated body in such a way that the brightness is uniform throughout the to-be-illuminated body in the planar direction.

Moreover, in this embodiment, by virtue of the second curved portion 1123 of the lens 112, the transmitted light B4 can be applied to the outer-edge region C4 of the peripheral to-be-illuminated region C3. This makes it possible to increase the quantity of light applied to the outer-edge region C4 which is part of the peripheral to-be-illuminated region C3 to which the transmitted light B3 cannot be directed readily, and thereby attain a higher degree of uniformity in light quantity within the peripheral to-be-illuminated region C3. In consequence, light can be illuminated on a to-be-illuminated body with a higher degree of uniformity in the brightness of the to-be-illuminated body in the planar direction.

Further, as has already been described, it is desirable to form a diffusing part for light diffusion at a midportion of the central portion 1121 of the lens 112 in the planar direction. By forming the diffusing part at the planar midportion of the central portion, of the transmitted light B1, a light portion which has passed through the planar midportion can be applied to the central to-be-illuminated region C2 while being diffused over a wide range. This makes it possible to attain a higher degree of uniformity in light quantity within the central to-be-illuminated region C2. In consequence, light can be illuminated on a to-be-illuminated body with a higher degree of uniformity in the brightness of the to-be-illuminated body in the planar direction.

According to the liquid-crystal display apparatus 100 equipped with the backlight unit 1 thus far described, by virtue of the backlight unit 1, light can be applied to the diffusion plate 3, which is the to-be-illuminated body, in such a way that the brightness is uniform throughout the diffusion plate 3 in the planar direction. Accordingly, light can be illuminated on the liquid-crystal panel 2 disposed in parallel with the diffusion plate 3 in such a way that the brightness is uniform throughout the liquid-crystal panel 2 in the planar direction. This allows the liquid-crystal display apparatus 100 to perform display of high-quality images.

The technology may be embodied in other specific forms without departing from the spirit or essential characteristics thereof. The present embodiments are therefore to be considered in all respects as illustrative and not restrictive, the scope of the technology being indicated by the appended claims rather than by the foregoing description and all changes which come within the meaning and the range of equivalency of the claims are therefore intended to be embraced therein.

What is claimed is:

1. A light-emitting device for applying light to a body to be illuminated, comprising:
a light-emitting element that emits light;
a lens disposed face-to-face with the light-emitting element while covering the light-emitting element, the lens including a transmitting region for light transmission and a reflecting region for light reflection which surrounds the transmitting region; and
a reflective member that reflects light, the reflective member being disposed around the lens,
an area δ [cm²] of a figure defining a contour of the reflective member as planarly viewed in an optical-axis direction parallel to an optical axis of the light-emitting element, being determined on a basis of γ×β/α, in which a quantity of light which exits from the lens through the transmitting region is represented by a [lm·s], a quantity of light which exits from the lens through an entire surface of the lens is represented by β [lm·s], and an area of the lens as planarly viewed in the optical-axis direction is represented by γ [cm²].

2. The light-emitting device of claim 1, wherein the area δ [cm²] fulfills the following formula (1):
γ×β/α×90%≦δ≦γ×β/α×100% (1).

3. The light-emitting device of claim 1, wherein the transmitting region has a diffusing part for light diffusion therein.

4. The light-emitting device of claim 1, wherein the lens has a second transmitting region surrounding the reflecting region, for transmitting light in such a way that the light travels in a direction farther away from the optical axis than the light which passes through the transmitting region.

5. A display apparatus comprising:
a display panel; and
an illuminating apparatus equipped with the light-emitting device of claim 1, the illuminating apparatus applying light so that the display panel can be illuminated with light at its back.

6. A method for designing a reflective member of a light-emitting device comprising a light-emitting element that emits light, a lens disposed face-to-face with the light-emitting element while covering the light-emitting element, the lens including a transmitting region for light transmission and a reflecting region for light reflection which surrounds the transmitting region, and the reflective member that reflects light, the reflective member being disposed around the lens, the method comprising:
a step of measuring α [lm·s] representing a quantity of light which exits from the lens through the transmitting region;
a step of measuring β[lm·s] representing a quantity of light which exits from the lens through an entire surface of the lens;
a step of measuring γ [cm²] representing an area of the lens as planarly viewed in an optical-axis direction parallel to an optical axis of the light-emitting element; and
a step of determining an area δ [cm²] of a figure defining a contour of the reflective member as planarly viewed in the optical-axis direction parallel within a range from a lower limit represented as γ×β/α×90% to an upper limit represented as γ×β/α×100%, and then designing the reflective member so as to fulfill a thusly determined value.
